(19) United States
(12) Patent Application Publication
(10) Pub. No.: US 2026/0236290 A1
(43) Pub. Date: Aug. 13, 2026

(54) TRANSACTION ROUTING AND REMEDIATION TRANSACTION PAIRING WITHIN A DECENTRALIZED NETWORK

(71) Applicant: Bank of America Corporation, Charlotte, NC (US)

(72) Inventors: Srinivas Allumolu, Charlotte, NC (US); Sakshi Bakshi, New Delhi (IN); George Albero, Charlotte, NC (US); Naga Vamsi Krishna Akkapeddi, Charlotte, NC (US); Siva S. Potla, Charlotte, NC (US)

(21) Appl. No.: 19/052,461

(22) Filed: Feb. 13, 2025

(51) Int. Cl. G06Q 20/38; G06F 9/50

(52) U.S. Cl. CPC G06F 9/466; G06F 9/4806; G06F 9/5044; G06Q 20/382; G06Q 2220/00

(57) ABSTRACT

A method for monitoring and routing a transaction within a decentralized network is provided. The method being performed by a central server in communication with a plurality of servers. The method may include analyzing transaction data included in a first soft token received from a first server to determine if a first routine for processing the transaction was executed successfully. The method may include analyzing transaction data included in a second soft token received from a second server to determine if a second routine for processing the transaction was executed successfully by the second server. In response to determining that the second routine failed to execute, the method may include transmitting a hard token to each of the plurality of servers for determining, a server that comprises computing resource capabilities for successfully executing the second routine, the hard token generated based on data in the second soft token.

### FIELD OF TECHNOLOGY

Aspects of the disclosure relate to routing and processing of transactions in a decentralized network.

### BACKGROUND OF THE DISCLOSURE

Transaction processing in a decentralized network typically involves multiple servers. Each server performs a step of the transaction processing. The cumulative result of the transaction processing steps is the successful processing of the transaction.

Because of the decentralized nature of the network, a first server can incorrectly execute its associated transaction processing step. This can lead to a cascade of undesirable results, when the unsuccessfully-processed transaction is repeatedly transmitted to subsequent servers for further processing.

It would be desirable, therefore, to provide systems and methods for a centralized monitoring system that reviews the transaction processing steps and enforces accuracy standards. It would be further desirable to provide systems and methods to support communication between the servers and the centralized monitoring system to provide accurate feedback regarding the transaction processing and, in addition, real-time data regarding transaction status.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative diagram in accordance with principles of the disclosure.

FIG. 2 shows an illustrative diagram in accordance with principles of the disclosure.

FIG. 3A shows an illustrative flow chart in accordance with principles of the disclosure.

FIG. 3B shows an illustrative flow chart in accordance with principles of the disclosure.

FIG. 4 shows an illustrative block diagram in accordance with principles of the disclosure.

FIG. 5 shows an illustrative apparatus that may be configured in accordance with principles of the disclosure.

### DETAILED DESCRIPTION OF THE DISCLOSURE

A decentralized network for monitoring and routing a transaction along a transaction path is provided. The network may include a central transaction monitor server and a plurality of servers. The plurality of servers may include a first server and a second server. The central transaction monitor server may be in communication with the plurality of servers.

The transaction may be initiated at the first server. The transaction may pass through one, two, three or more of the plurality of servers for completing the processing of the transaction. The servers that the transaction may pass through, may be included in the transaction path. The transaction may be transmitted along an alternate transaction path when a failure occurs.

Each of the plurality of servers may operate independent of the remaining plurality of servers within the decentralized network.

For the purposes of the disclosure, a transaction may include a financial transaction at a financial institution, an online transaction at any e-commerce site, an in-store purchase or any other suitable transaction. Each transaction may include a plurality of application hops through systems, applications and/or vendors that may include different security protocols, respective infrastructures and processing capabilities.

The network may include the first server. The first server may be configured to initiate a processing of the transaction by executing a first routine. The first routine may be a set of transaction processing steps. Each server may perform a unique set of processing steps for advancing the processing of the transaction.

Each server, following execution of a set of processing steps for the transaction, may generate a soft token. The soft token may include data corresponding to the set of processing steps, the transaction and the server.

Each soft token may include a set of data that may be converted to a hash. The converting may protect the data. Each soft token may be stored temporarily. Each soft token generated by a server may be accessed and shared for the duration of the transaction. Each soft token may preferably not utilize any physical space or value. Each soft token may be transaction specific, and maintenance may preferably not be necessary.

Each soft token may be transmitted to the central transaction monitor server for tracking and monitoring.

The first server may be configured to, following the execution of the first routine, generate and transmit a first soft token to the central transaction monitor server.

The first soft token may include first server identification (“ID”), transaction data and a transaction status. First server ID may be an ID that is unique to the first server. Tagging the unique ID to each soft token may enable tracing the transaction origin and tracing the transaction path.

The transaction data may include a type of transaction, a timestamp associated with the transaction, a source of the transaction, a time zone, an origin trace ID and any other suitable transaction data. The transaction data may also include a transaction ID.

The transaction data may also include computing resources that may be required for execution of the transaction. The transaction data may also include systems, applications and vendors involved in the transaction.

The transaction data may also include a map of the transaction path. The map may include a server ID for each server in the transaction path. The transaction data may be updated at each server. When a failure occurs and the transaction is rerouted to a different server/application, the server/application that remediates the failure may be added to the map.

The map may log each step in the transaction. The map may be stored, following the completion of the transaction, for auditing and for optimizing subsequent transaction paths generated.

For each soft token, the transaction ID may be concatenated with the ID unique to the server to create a transaction key. The transaction key may further enable tracing the flow of the transaction from initiation to completion.

The transaction status may refer to a current state of the transaction. The state of the transaction may include a success or failure of the execution of the routine being executed at the server. The state of the transaction may also include whether the transaction is pending or completed. At each server, following the execution of the routine being executed at the server, the transaction status may be updated.

The transaction status may include an updated status of the transaction based on routine functions executed at each server.

The data included in the soft token may be converted into a hash. The hash may be generated by a hash generator that may be running at the first server. The hash generator may include a hash generation application stored at each server. The hash generation application, in some embodiments, may be running at the central transaction monitor server or at any other server or computing device.

The soft token may be stored in a temporary storage until the transaction is completed. Illustrative temporary storage may include random access memory (“RAM”) or any other suitable temporary storage. Storing the soft token in a temporary storage may eliminate excess data stored in permanent memory that may not be needed. The soft token may be stored in the temporary storage for a pre-determined time period to enable auditing the transaction following the completion of the transaction. The auditing may include accessing the soft token. Following a lapse of the pre-determined time period, the soft token may be permanently deleted from the temporary storage.

The pre-determined time period may preferably exceed an estimated time for occurrence of a transaction. The estimated time may be a time that may exceed the expected duration of the transaction. In some embodiments, a trigger of a completion of the transaction may be the trigger to delete the token.

When a failure occurs, the soft token may be converted to a hard token. The hard token may be stored in permanent storage. The permanent storage may be located at each server. The permanent storage may be located at the central transaction monitor server. The permanent storage may be stored on a blockchain. The hard token may enable access to the data of the transaction via each of the plurality of server which may not be enabled via the soft token. In the event of a termination of the soft token following the pre-determined time period, the data of the transaction may not be accessible. Following a conversion of the soft token to the hard token, the data may be stored permanently and enabled to be accessed via each of the servers.

Data included the hard token may be the same data stored in the soft token. Permanent storage of the hard token may enable each of the plurality of servers to access the data in the hard token to enable a remediation of the failure at a later point in time.

Following the executing of the first routine, the first server may be configured to transmit the transaction to the second server to continue the transaction processing.

The second server may be configured to execute a second routine on the transaction to continue the transaction processing. In response to the execution of the second routine, the second server may be configured to update the transaction status.

The second server may also be configured to generate a second soft token. The second soft token may include second server ID, the transaction data and the updated transaction status. The data may be converted into a hash. The second soft token may be transmitted to the central transaction monitor server.

The central transaction monitor server may be configured to analyze each soft token received. The central transaction monitor server may keep track of the flow of the transaction based on each soft token received.

The central transaction monitor server may leverage a central token categorizer for classifying and analyzing the soft tokens. The central transaction monitor may be configured to analyze the first soft token upon receipt of the first soft token. The analyzing may be for determining if the first routine was executed successfully. The determination may be based, at least in part, on the transaction status.

The central transaction monitor server may be configured to analyze the second soft token upon receipt of the first soft token. The analyzing may be for determining if the second routine was executed successfully. The determination may be based, at least in part, on the transaction status.

In response to a determination that the second routine failed to execute, the central transaction monitor server may be configured to transmit an instruction to the second server to generate a hard token based on data in the second soft token.

In response to a receipt of the instruction at the second server, the second server may be configured to convert the soft token into a hard token. The second server may store the transaction data and generate the hard token based on the transaction data. In the event that the second server cannot access the transaction data, the central transaction monitor server may transmit an instruction to the first server to generate the hard token based on the transaction data stored at the first server.

The central transaction monitor server may be configured to receive the hard token from the second server. The central transaction monitor server may further be configured to transmit the hard token to the plurality of servers.

In response to receipt of the hard token, each of the plurality of servers may be configured to extract data from the hard token. Each of the servers may analyze the data to determine computing resource capabilities for successfully executing the second routine. The determination may be based at least in part on the extracted data. Each server may analyze the origin of the transaction, the type of transaction and the processing steps needed to be executed in order to determine whether the server may be enabled to handle the processing.

In response to the analysis, via each of the servers, the central transaction monitor may be configured to receive a response from a third server included in the plurality of servers. The third server may determine that the third server has the computing resource capabilities for successfully executing the second routine.

The third server may be paired to the second soft token. The pairing may be a key-value pair. The soft token may be the key and the server may be the value. In response to a successful pairing, the second routine may be executed via the third server, wherein a functionality of the third server may be the same or substantially similar to the second server.

The third server may be configured to execute the second routine. In response to the execution of the second routine, the third server may be configured to generate a third soft token. The third soft token may then be transmitted to the central transaction monitor server for tracking the transaction status. The third soft token may include third application identification (“ID”), the transaction data and the transaction status.

In some embodiments, the third routine may be the final routine for completing the execution of the transaction. In some embodiments, the third server may transmit the transaction to a fourth server for continuing the processing. The fourth server may be included in the plurality of servers.

Following execution of the second routine at the third server, the transaction may revert to the original transaction path. In some embodiments, the transaction may reroute on a different set of servers from the original servers designated for the original transaction path.

A method for monitoring and routing a transaction along a transaction path is provided. The method may be performed by a central transaction monitor server.

The method may include analyzing transaction data included in a first soft token upon receipt of the first soft token from the first server. The analyzing may be for determining if a first routine from a plurality of routines for processing the transaction was executed successfully by the first server.

The method may include analyzing transaction data included in a second soft token upon receipt of the second soft token from the second server. The analyzing may be for determining if a second routine from the plurality of routines for processing the transaction was executed successfully by the second server.

In response to determining that the second routine failed to execute, the method may include transmitting an instruction to the second server to generate a hard token based on data in the second soft token.

The method may include receiving the hard token from the second server.

The method may include transmitting the hard token to each of the plurality of servers. The transmitting for determining, by each of the plurality of servers, a server that may have the capacity to successfully execute the second routine based at least in part on the transaction data. The server may determine whether the server has the computing resource capabilities for executing the second routine.

In response to receipt of a response from a third server included in the plurality of servers, the third server having determined that it has computing resource capabilities for successfully executing the second routine, the method may include pairing the transaction to the third server for continuing the processing in place of the second server.

Following the pairing, the third server may be configured to execute the second routine. In response to a successful execution of the second routine, the central transaction monitor server may be configured to log data associated with the pairing for auditing. The logging may be a real-time logging. The central transaction monitor server may further be configured to transmit the log to each of the servers. By logging details and data of the transactions following the pairing, a trail of the auditing may enable tracing and/or troubleshooting via each of the servers in the plurality of servers.

The data log may include data from each device within the decentralized network. The logging may enable tracing and auditing the transaction trail from the first device initiating the execution to the final device completing the transaction.

The logging of the data may be performed via a Bidirectional Encoder Representations from Transformers (“BERT Transformer”). A BERT transformer is a natural language processing model that may analyze text by analyzing the text both before and after the specified text. BERT Transformers may be a high-speed transformer and may log the transactions in real-time.

Illustrative embodiments of apparatus and methods in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

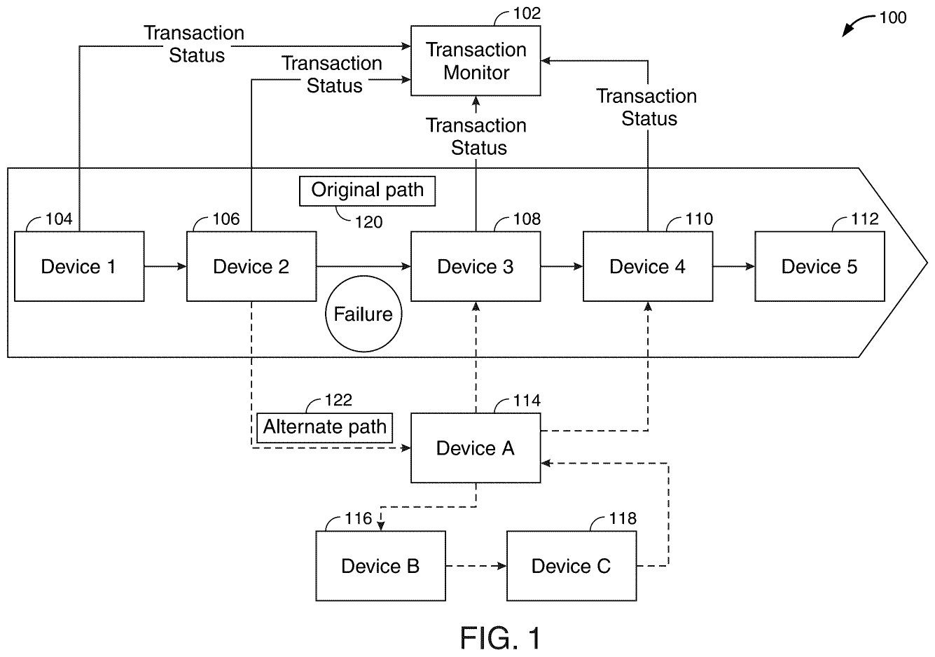

FIG. 1 shows an illustrative exemplary diagram 100 in accordance with principles of the disclosure.

An original transaction path for a transaction may be displayed at 120. The original transaction path may include device 1 at 104, device 2 at 106, device 3 at 108, device 4 at 110 and device 5 at 112. Each of devices 104-112 may be a computing device, i.e.—an internet of things device (“IoT”), a server, or any other computing device. Each of devices 104-112 may include an application running on the computing device for execution of each transaction.

Transaction monitor 102 may also be in electronic communication with device A at 114, Device B at 116 and Device C at 118. In this exemplary diagram, devices A-C may not be included in the original path 120. Devices A-C may be leveraged when a failure occurs during the duration of the execution of the transaction.

Transaction monitor 102 may be running on a central server. Transaction monitor 102 may be in electronic communication with each device.

In this exemplary diagram 100, a transaction is initiated at device 104 and is completed at device 112.

Following an initiation of a transaction at device 1, 104, device 104 may execute a set of processing steps and further generate, following the execution of the processing steps, a soft token including metadata associated with the transaction and a transaction status. Device 104 may transmit the soft token to the transaction monitor 102 for tracking the transaction. Device 104 may transmit the transaction to device 2, at 106 for continuing the processing.

Device 2, at 106 may execute another set of processing steps and further generate, following the execution, a soft token including updating the transaction status. Device 2, at 106 may transmit the soft token to transaction monitor 102. Transaction monitor 102 may identify that the set of processing steps at device 2 failed to execute successfully.

In response to the failure, device 2, at 106 may convert the soft token to a hard token. The converting may include transferring all the data from the soft token to the hard token. The hard token may be enabled to be transmitted to a plurality of devices for determining a device that can perform the set of processing steps that failed to execute.

Devices 114-118 may analyze the data in the hard token for determining availability and capability of remediating the failure. Devices 104, 108, 110, 112 or any other device may also analyze the data for determining availability and capability for remediating the failure.

At least one of devices 114-118 and/or 104, 108, 110 and 112 may determine to be available. In response to the determination, the available device may execute the processing steps that had previously failed and transmit the transaction to the next device in the original transaction path.

In some embodiments, device A at 114 may be the available device and the transaction may be rerouted on an alternate transaction path 122. Alternate transaction path 122 may revert to device 3 at 108. In some embodiments alternate transaction path 122 may reroute the transaction via device 116 and device 118 and then continue at device 4 at 110.

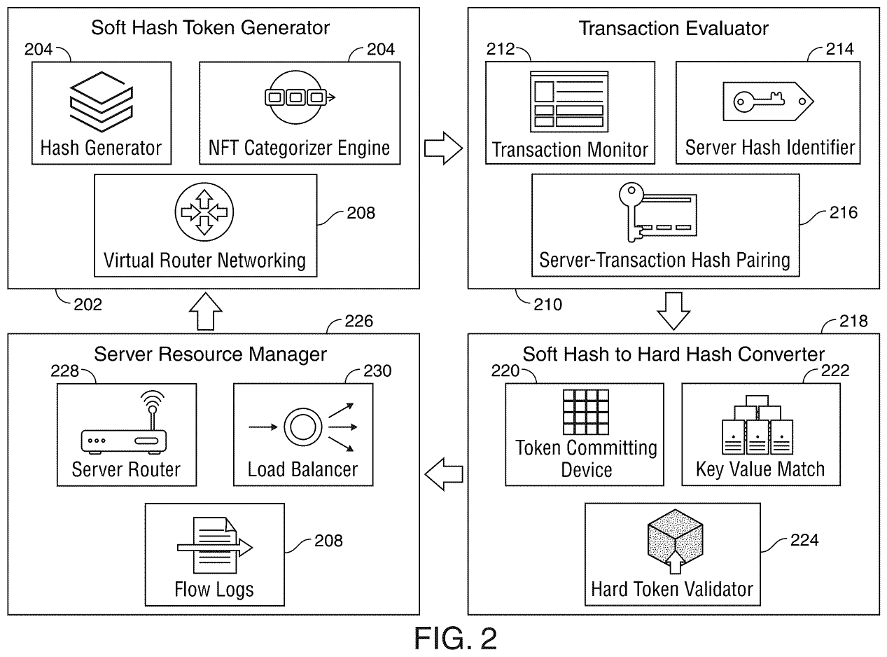

FIG. 2 shows an illustrative diagram of the components that may be included in the processing of transactions.

Soft hash token generator 202 may include a hash generator 204, NFT categorizer engine 206 and a virtual router networking 208. Soft hash token generator 202 may be an application running on each server. Soft hash token generator 202 may be running at the remote transaction monitor server. In some embodiments, soft hash token generator 202 may be accessed via a third party application.

When a soft token is generated based on metadata associated with the transaction, the metadata included in the soft token may be converted to a hash via hash generator 204. In some embodiments, the token may be a non-fungible token (“NFT”). An NFT categorizer engine 204 may manage the soft tokens.

Virtual router networking 208 may route each soft token between each device. Virtual router networking 208 may route each soft token between the central transaction monitor server and each of the devices. Virtual router networking 208 may determine an optimal path for the routing of the transaction.

Transaction evaluator 210 may include transaction monitor 212, server hash identifier 214 and server-transaction hash pairing 216. Transaction evaluator 210 may run transaction monitor 212 executed at the central transaction monitor server for monitoring the transaction from initiation to completion.

Server hash identifier 214 may identify each server within the transaction path. Each server may include a unique ID that may be included in the soft token generated at each of the plurality of servers. Server hash identifier may concatenate the server ID together with the transaction ID.

Server-transaction hash pairing 216 may be an application executed at the central transaction monitor server for pairing the transaction to each server within the transaction path.

Soft hash to hard hash converter 218 may include a token committer 220, a key value match 222 and a hard token validator 224.

Soft hash to hard hash converter 218 may be an application executed when converting a soft token to a hard token.

Key value match 222 may enable matching tokens to applications to form a pair. Each token may pair to an application of the server where the transactions are being processed. For this key-value pairing, there may be multiple factors being identified for a successful pairing. The factors may include infrastructure of each application/server, processing capabilities at each server, resource capabilities and type of transaction.

Token committing device 220 may commit the key-value pairs. Hard token validator 224 may perform a reconciliation to validate whether the transaction happened as expected or not. Hard token validator 224 may validate the transaction path to determine a success of the execution and to further determine whether the transaction is completed or not.

In response to the validating, server resource manager 226 may manage the resources for allocating each transaction on a transaction path. Server resource manager 226 may leverage the data stored in the hard token to identify optimal paths for each subsequent transaction.

Server resource manager 226 may include server router 228, load balancer 230 and flow logs 232. Server router 228 may be the router for each server. Load balancer 230 may identify and determine the capabilities and resources available for each server. Load balancer 230 may distribute network traffic across the multiple servers or computing resources. This may enable effectively spreading the processing of the transaction evenly to optimize performance, improve application responsiveness, and prevent any single server from becoming overloaded, ensuring high availability and reliability

Each application running on each server may determine the load balancing capability by monitoring the performance of the server. Each application may communicate the load to a dedicated load balancer for routing the transactions.

Flow logs 208 may generate a log of the processing of each transaction. The logging may include logging details and data of the transactions following a successful pairing. A trail of the auditing may enable tracing and/or troubleshooting via each of the servers in the plurality of servers.

It should be appreciated that each soft hash token generated may not be stored permanently, however the data may be retained from the soft token for remediating a failure and/or for machine learning possibilities and for reinvigoration of a transaction.

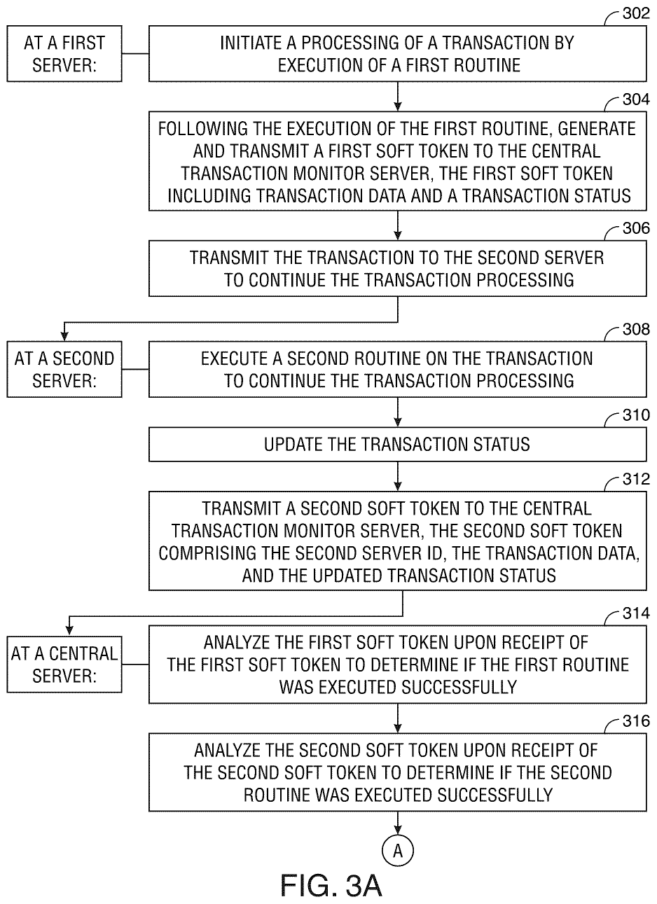

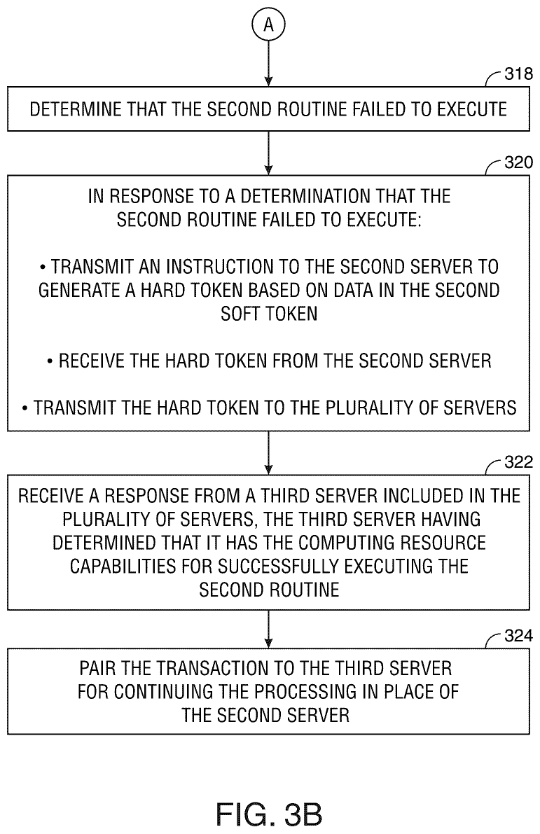

FIG. 3A shows an illustrative flow chart of the steps for routing a transaction in accordance with principles of the disclosure.

At a first server, at step 302, the first server may be configured to initiate a processing of a transaction by execution of a first routine.

At step 304, the first server may be configured to, following the execution of the first routine, generate and transmit a first soft token to the central transaction monitor server. The first soft token may include transaction data and a transaction status.

At step 306, the first server may be configured to transmit the transaction to the second server to continue the transaction processing.

At a second server, at step 308, the second server may be configured to execute a second routine on the transaction to continue the transaction processing.

Following the execution of the second routine, the transaction status may be updated, as shown at 310.

At step 312, the second server may be configured to transmit a second soft token to the central transaction monitor server. The second soft token may include the transaction data and the updated transaction status.

At the central server, at 314, the central server may be configured to analyze the first soft token upon receipt of the first soft token to determine if the first routine was executed successfully.

At step 316, the central server may be configured to analyze the second soft token upon receipt of the second soft token to determine if the second routine was executed successfully.

FIG. 3B shows an illustrative flow chart of the steps for routing a transaction in accordance with principles of the disclosure. The steps in FIG. 3B are a continuation to the steps in FIG. 3A.

At step 318, the central server may be configured to determine that the second routine failed to execute.

At step 320, in response to a determination that the second routine failed to execute, the central server may be configured to transmit an instruction to the second server to generate a hard token, the hard token based at least in part on data in the second soft token.

The central server may be further configured to receive the hard token from the second server and transmit the hard token to the plurality of servers.

At step 322, the central server may be configured to receive a response from a third server included in the plurality of servers. The third server may determine to have the computing resource capabilities for successfully executing the second routine.

At step 324, the central server may be configured to pair the transaction to the third server for continuing the processing in place of the second server.

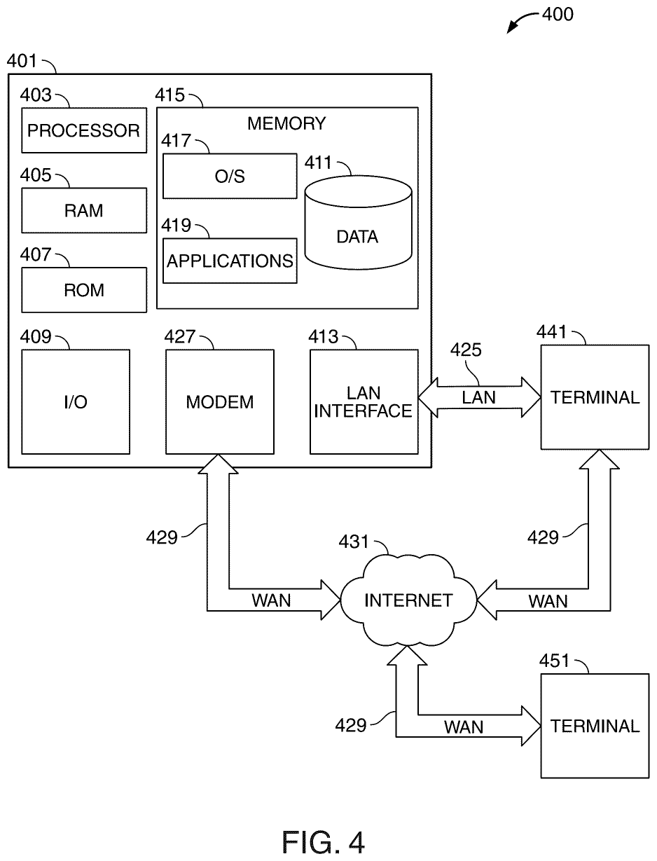

FIG. 4 shows an illustrative block diagram of system 400 that includes computer 401. Computer 401 may alternatively be referred to herein as an “engine,” “server” or a “computing device.” The computing system may include one or more computer servers 401. Computer 401 may be any computing device described herein, such as the central transaction monitor server, each of the plurality of servers or any other suitable computing device. Elements of system 400, including computer 401, may be used to implement various aspects of the systems and methods disclosed herein.

Computer 401 may have a processor 403 for controlling the operation of the device and its associated components, and may include RAM 405, ROM 407, input/output circuit 409, and a non-transitory or non-volatile memory 415. Machine-readable memory may be configured to store information in machine-readable data structures. Other components commonly used for computers, such as EEPROM or Flash memory or any other suitable components, may also be part of the computer 401.

The memory 415 may be comprised of any suitable permanent storage technology—e.g., a hard drive. The memory 415 may store software including the operating system 417 and application(s) 419 along with any data 411 needed for the operation of computer 401. Memory 415 may also store videos, text, and/or audio assistance files. The data stored in Memory 415 may also be stored in cache memory, or any other suitable memory.

Input/output (“I/O”) module 409 may include connectivity to a microphone, keyboard, touch screen, mouse, and/or stylus through which input may be provided into computer 401. The input may include input relating to cursor movement. The input/output module may also include one or more speakers for providing audio output and a video display device for providing textual, audio, audiovisual, and/or graphical output. The input and output may be related to computer application functionality.

Computer 401 may be connected to other systems via a local area network (LAN) interface 413. Computer 401 may operate in a networked environment supporting connections to one or more remote computers, such as terminals 441 and 451. Terminals 441 and 451 may be personal computers or servers that include many or all of the elements described above relative to computer 401.

When used in a LAN networking environment, computer 401 is connected to LAN 425 through a LAN interface 413 or an adapter. When used in a WAN networking environment, computer 401 may include a modem 427 or other means for establishing communications over WAN 429, such as Internet 431.

In some embodiments, computer 401 may be connected to one or more other systems via a short-range communication network (not shown). In these embodiments, computer 401 may communicate with one or more other terminals 441 and 451, using a PAN such as Bluetooth®, NFC, ZigBee, or any other suitable personal area network.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 419, which may be used by computer 401, may include computer executable instructions for invoking functionality related to communication, such as e-mail, Short Message Service (SMS), and voice input and speech recognition applications. Application program(s) 419 (which may be alternatively referred to herein as “plugins,” “applications,” or “apps”) may include computer executable instructions for invoking functionality related to performing various tasks. Application programs 419 may utilize one or more algorithms that process received executable instructions, perform power management routines or other suitable tasks. Application programs 419 may include soft hash token generator 202, transaction evaluator 210, soft hash to hard hash converter 218, server resource manager 226 and any other applications described herein.

Application program(s) 419 may include computer executable instructions (alternatively referred to as “programs”). The computer executable instructions may be embodied in hardware or firmware (not shown). The computer 401 may execute the instructions embodied by the application program(s) 419 to perform various functions.

Application program(s) 419 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 419 may include one or more algorithms that may be used to implement features of the disclosure.

The invention may be described in the context of computer-executable instructions, such as applications 419, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 401 and/or terminals 441 and 451 may also include various other components, such as a battery, speaker, and/or antennas (not shown). Components of computer system 401 may be linked by a system bus, wirelessly or by other suitable interconnections. Components of computer system 401 may be present on one or more circuit boards. In some embodiments, the components may be integrated into a single chip. The chip may be silicon-based.

Terminal 451 and/or terminal 441 may be portable devices such as a laptop, cell phone, Blackberry™, tablet, smartphone, or any other computing system for receiving, storing, transmitting and/or displaying relevant information. Terminal 451 and/or terminal 441 may be one or more user devices. Terminals 451 and 441 may be identical to computer 401 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smart phones, multiprocessor systems, microprocessor-based systems, cloud-based systems, programmable consumer electronics, network PCs, minicomputers, mainframe computers, distributed computing environments that include any of the above systems or devices, and the like.

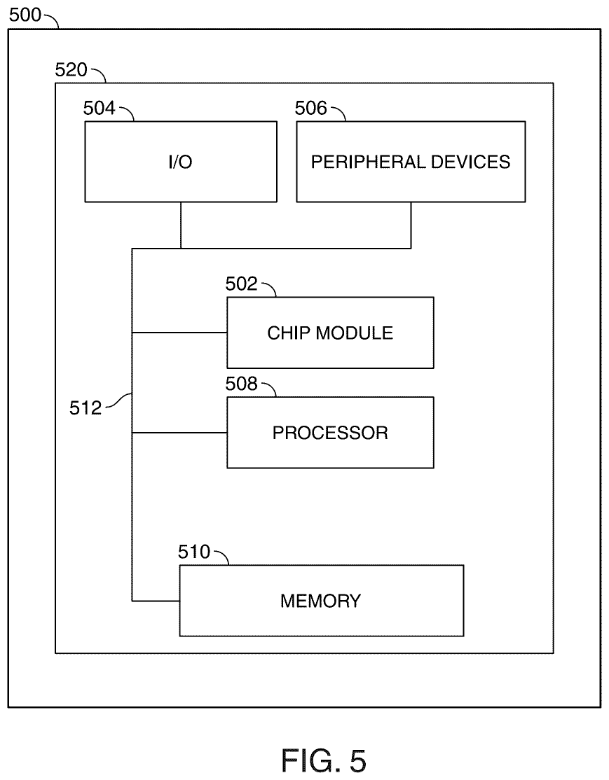

FIG. 5 shows illustrative apparatus 500 that may be configured in accordance with the principles of the disclosure. Apparatus 500 may be a computing device. Apparatus 500 may include chip module 502, which may include one or more integrated circuits, and which may include logic configured to perform any other suitable logical operations.

Apparatus 500 may include one or more of the following components: I/O circuitry 504, which may include a transmitter device and a receiver device and may interface with fiber optic cable, coaxial cable, telephone lines, wireless devices, PHY layer hardware, a keypad/display control device or any other suitable media or devices; peripheral devices 506, which may include counter timers, real-time timers, power-on reset generators or any other suitable peripheral devices; logical processing device 508, which may compute data structural information and structural parameters of the data; and machine-readable memory 510.

Machine-readable memory 510 may be configured to store in machine-readable data structures: machine executable instructions, (which may be alternatively referred to herein as “computer instructions” or “computer code”), applications such as applications 519, signals, and/or any other suitable information or data structures.

Components 502, 504, 506, 508 and 510 may be coupled together by a system bus or other interconnections 512 and may be present on one or more circuit boards such as circuit board 520. In some embodiments, the components may be integrated into a single chip. The chip may be silicon-based.

Thus, systems and methods for monitoring and routing a transaction along a transaction path within a decentralized network is provided. Persons skilled in the art will appreciate that the present invention can be practiced by other than the described embodiments, which are presented for purposes of illustration rather than of limitation.

1. A decentralized network comprising a central transaction monitor server and a plurality of servers including a first server and a second server, the central transaction monitor server being in electronic communication with the plurality of servers for optimizing a transaction path selected for routing and processing of a transaction between the plurality of servers, the network comprising:
the first server being configured to, using a first processor:
initiate a processing of the transaction by executing a first routine;
following the execution of the first routine, generate first soft token to the central transaction monitor server, the first soft token comprising a first set of data including first server identification (“ID”), transaction data and a transaction status, the first soft token being maintained for a pre-determined time period;
convert the first set of data into a first hash;
transmit the first soft token comprising the hashed first set of data to the central server; and
transmit the transaction to the second server to continue the transaction processing;
the second server being configured to, using a second processor:
execute a second routine on the transaction to continue the transaction processing;
update the transaction status;
generate a second soft token, the second soft token comprising a second set of data comprising a second server ID, the transaction data, and the updated transaction status, the second soft token being maintained for the pre-determined time period;
convert the second set of data into a second hash; and
transmit the second soft token comprising the hashed second set of data to the central transaction monitor server;
the central transaction monitor server configured to, using a central server processor:
analyze the first soft token upon receipt of the first soft token to determine if the first routine was executed successfully;
analyze the second soft token upon receipt of the second soft token to determine if the second routine was executed successfully; and
in response to a determination that the second routine failed to execute:
transmit an instruction to the second server to generate a hard token based on data in the second soft token;
store the hard token in permanent storage, the storing enabling accessing the hard token via each of the plurality of servers; and
in response to a receipt of the hard token from the second server, transmit the hard token to the plurality of servers;
in response to receipt of the hard token, each of the plurality of servers being configured to, via a load balancer running on each of the servers:
extract data from the hard token; and
determine computing resource capabilities for successfully executing the second routine based at least in part on the extracted data; and
the central transaction monitor server configured to:
receive a response from a third server included in the plurality of servers, the third server having determined that it has computing resource capabilities for successfully executing the second routine; and
pair the transaction to the third server for continuing the processing in place of the second server;
the third server configured to, using a third processor:
execute the second routine;
generate a third soft token, the third soft token comprising a third set of data comprising third application identification (“ID”), the transaction data and the transaction status;
convert the third set of data to a third hash;
transmit the third soft token comprising the hashed third set of data to the central transaction monitor server for tracking a transaction status; and
transmit the transaction to a fourth server for continuing the processing, the fourth server included in the plurality of servers;
the fourth server configured to, using a fourth processor, complete the processing of the transaction; and
the central transaction monitor server configured to, following a completing of the transaction, permanently delete the first soft token, the second soft token and the third soft token from temporary storage.

2. (canceled)

3. The network of claim 1 wherein the transaction status comprises a success or failure of the first routine and the second routine.

4. The network of claim 1 wherein each of the first soft token and the second soft token is stored in transient memory.

5. The network of claim 1 wherein following the lapse of the pre-determined time period, the central transaction monitor server is configured to delete each of the first soft token and the second soft token.

6. The network of claim 5 wherein the pre-determined time period exceeds an estimated time of the processing of the transaction.

7. The network of claim 1 wherein the transaction data comprises a transaction ID, a transaction type, a timestamp and a time zone.

8. The network of claim 7 wherein the transaction data further comprises computing resources required for executing the transaction.

9. The network of claim 7 wherein the transaction data further comprises a map of the transaction path.

10. The network of claim 1 wherein the pairing of the third server to the hard token is a key-value pair, the hard token being a key and the third server being a value.

11. The network of claim 10 wherein following the pairing, the third server is configured to execute the second routine.

12. The network of claim 11 wherein, in response to the execution, the central transaction monitor server is configured to:
log data associated with the pairing, the logging enabling auditing of the transaction; and
transmitting the log to each of the servers.

13. A method for optimizing a transaction path selected for routing and processing of a transaction between a plurality of servers, the method performed by a central transaction monitor server, the central transaction monitor server being in electronic communication with the plurality of servers, the plurality of servers including a first server and a second server, the method comprising:
initiating a processing of the transaction by executing a first routine;
analyzing transaction data included in a first soft token upon receipt of the first soft token from the first server, the analyzing for determining if the first routine from a plurality of routines for processing the transaction was executed successfully by the first server, the first soft token being maintained for a pre-determined time period;
in response to determining that the first routine was executed successfully, executing a second routine;
analyzing transaction data included in a second soft token upon receipt of the second soft token from the second server, the analyzing for determining if the second routine from the plurality of routines for processing the transaction was executed successfully by the second server, the second soft token being maintained for the pre-determined time period; and
in response to determining that the second routine failed to execute:
transmitting an instruction to the second server to generate a hard token based on data in the second soft token, the hard token being stored permanently thereby enabling accessing the hard token via each of the plurality of servers;
receiving the hard token from the second server;
transmitting the hard token to each of the plurality of servers, the transmitting for determining, by each of the plurality of servers, a server that comprises computing resource capabilities for successfully executing the second routine based at least in part on the transaction data; and
in response to receipt of a response from a third server included in the plurality of servers, the third server having determined that it has computing resource capabilities for successfully executing the second routine, pairing the transaction to the third server for continuing the processing in place of the second server;
executing a third routine;
analyzing transaction data included in a third soft token upon receipt of the third soft token from the third server, the analyzing for determining if the third routine from the plurality of routines for processing the transaction was executed successfully by the third server, the third soft token being maintained for the pre-determined time period;
transmitting the transaction to a fourth server for continuing the processing, the fourth server included in the plurality of servers; and
following a completing of the transaction, deleting permanently the first soft token, the second soft token and the third soft token from temporary storage.

14. The method of claim 13 wherein the transaction data comprises a transaction ID, a transaction type, a timestamp, a time zone and a transaction status.

15. The method of claim 14 wherein the transaction status comprises an updated status of the transaction based on routine functions executed at each server.

16. The method of claim 15 wherein the transaction status comprises a success or failure of the transaction.

17. The method of claim 13 further comprising, following the pairing:
logging data associated with the pairing, the logging enabling auditing a trail of the transaction; and
transmitting the log to each of the servers.

18-20. (canceled)
